(19) United States
(12) Patent Application Publication
(10) Pub. No.: US 2022/0289096 A1
(43) Pub. Date: Sep. 15, 2022

(54) VEHICLE HAVING A LIVABLE SPACE AND METHODS OF MODIFYING A VEHICLE THERETO

(71) Applicant: Danny Zhida WU, Calgary (CA)

(72) Inventor: Danny Zhida WU, Calgary (CA)

(21) Appl. No.: 17/584,124

(22) Filed: Jan. 25, 2022

(30) Foreign Application Priority Data
Jan. 25, 2021 (CA) 3106941

(51) Int. Cl. B60P 3/34; B60R 15/02

(52) U.S. Cl. CPC B60P 3/34; B60R 15/02; B60N 2/30

(57) ABSTRACT

A vehicle has a main body enclosing a main interior space therein and a roof structure. The main interior space has a front-seating area having therein at least one front seat and a rear-seating area for receiving therein one or more rear seats. The main body has an opening on a roof thereof overlapping at least a portion of the rear-seating area. The roof structure is on top of the main body and coupled thereto for providing an additional space therein accessible from the main interior space through the opening. The main body has a shower pan on or in a floor thereof extending from a location in the rear-seating area towards a rear end of the main body. The one or more rear seats are reconfigurable for providing access to the shower pan.

### CROSS-REFERENCE TO RELATED APPLICATIONS

This application claims priority to Canadian Patent Application Serial No. 3,106,941, filed Jan. 25, 2021, the content of which is incorporated herein by reference in its entirety.

### FIELD OF THE DISCLOSURE

The present disclosure generally relates to a vehicle having a livable space, and in particular to a vehicle that may be used for both general commuting and as a temporary lodging with showering and sleeping areas.

### BACKGROUND

Recreational vehicles (RVs) are motor vehicles or trailers that have living quarters. While RVs are generally used for lodging while travelling, they may also be used as a longer-term residence. The living quarters of an RV typically include a kitchen area, a bathroom, and one or more areas for sleeping. RVs may be self-propelled (e.g. motorhomes and campervans) or towed (e.g. pop-up campers, caravans, and fifth-wheel trailers).

While a convenient accommodation for recreational activities such as travel and camping, RVs have several drawbacks that may limit their accessibility to consumers. First, the cost of RVs may be prohibitive to many consumers. Second, RVs are generally very large in size and motorhomes and many towed RVs typically need to be stored at a location other than the owner's residence when not in use. Third, self-propelled RVs consume large amounts of fuel and are typically not fuel efficient, and towed RVs decrease the fuel efficiency of the towing vehicle. Finally, many self-propelled RVs are not practical for general commuting purposes, requiring an owner to have a separate vehicle for daily use.

Roof tents, or “rooftop tents”, are an accessory that may be attached to the roof of a suitable vehicle to provide a sleeping space. Roof tents may be of a hard shell, a waterproof material, or a combination of both. While roof tents offer a convenient and comfortable sleeping alternative compatible with many commuter vehicles (e.g. sport utility vehicles and trucks), they do not provide all of the amenities of an RV such as, for example, a shower. While portable showers exist, they are typically designed for use outside of the vehicle and therefore are not amenable for use in adverse weather conditions. Further, roof tents are typically accessed from outside of the vehicle by, for example, a ladder, making their access less convenient in adverse weather conditions.

Therefore, there exists a need for vehicles that provide a multi-functional, livable space for leisure use (e.g. travel, camping, temporary accommodation) that may also be used for daily commuting. Specifically, there exists a need for sport utility vehicles having a shower and sleeping area accessible from inside of the vehicle.

### SUMMARY

The present disclosure provides a vehicle having a livable space and methods for modifying a conventional vehicle into a vehicle with a livable space.

According to one aspect of this disclosure, there is provided a vehicle comprising: a main body enclosing a main interior space therein, the main interior space comprising a front-seating area having therein at least one front seat and a rear-seating area for receiving therein one or more rear seats, the main body comprising an opening on a roof thereof overlapping at least a portion of the rear-seating area; and a roof structure on top of the main body and coupled thereto for providing an additional space therein accessible from the main interior space through the opening; the main body comprises a shower pan on or in a floor thereof extending from a location in the rear-seating area towards a rear end of the main body; and the one or more rear seats are reconfigurable for providing access to the shower pan.

In some embodiments, the one or more rear seats are removable for providing access to the shower pan.

In some embodiments, the one or more rear seats are slidable, foldable, and/or rotatable for providing access to the shower pan.

In some embodiments, the shower pan is permanently coupled to the floor.

In some embodiments, the shower pan is removably coupled to the floor.

In some embodiments, the shower pan is coupled to a recess of the floor of the main body.

In some embodiments, the shower pan is extendable.

In some embodiments, the shower pan is extendably coupled to at least one of the one or more rear seats.

In some embodiments, the shower pan is made of a flexible material.

In some embodiments, the shower pan longitudinally extends at least in a portion of the rear-seating area and laterally extends between two anchoring feet of the one or more rear seats.

In some embodiments, the main interior space further comprises a trunk area adjacent a rear end of the rear-seating area.

In some embodiments, the shower pan extends from the rear-seating area into the trunk area.

In some embodiments, the shower pan comprises a drain for draining a fluid from the shower pan to outside of the main body.

In some embodiments, the drain is in fluid communication with a drainage container below the floor.

In some embodiments, the main body further comprises a shower-pan cover for openably covering the shower pan.

In some embodiments, the shower-pan cover is removable.

In some embodiments, the shower-pan cover is rotatable between an open position for providing access to the shower pan and a closed position for covering the shower pan.

In some embodiments, the shower-pan cover is rotatable about a rear end thereof between the open position and the closed position.

In some embodiments, when the shower-pan cover comprises a structure for providing a privacy barrier when the shower-pan cover is in the open position.

In some embodiments, the main body further comprises a shower kit above the shower pan.

In some embodiments, the shower kit is removable.

In some embodiments, the shower kit is reconfigurable to a compact state and retracted to an upper end of the roof structure or to the shower pan for storage.

In some embodiments, the shower kit comprises a showerhead and a flexible shower enclosure.

In some embodiments, the shower enclosure comprises a plurality of magnetic blocks about a bottom thereof for removably engaging one or more ferromagnetic portions of a sidewall of the shower pan for removably retaining the bottom of the shower enclosure to the sidewall of the shower pan.

In some embodiments, the main body further comprises one or more water tanks positioned adjacent one or more lateral sidewalls thereof.

In some embodiments, the one or more water tanks are in fluid communication with the showerhead.

In some embodiments, the one or more water tanks comprise one or more flexible reservoirs.

In some embodiments, the main body further comprises a heating source for heating the additional space.

In some embodiments, the heating source is a boiler or a radiant heating source.

In some embodiments, the heating source is positioned adjacent the rear end of the main body.

In some embodiments, the main body further comprises one or more foldable tables and/or one or more foldable seats coupled to one or more sidewalls of the main body, at least one of the one or more rear seats, and/or one or more fixtures of the main body.

In some embodiments, the main body further comprises one or more cabinets.

In some embodiments, the one or more cabinets are located adjacent the rear end of the main body and are outwardly rotatable.

In some embodiments, the main body further comprises one or more convertible tables and/or one or more convertible seats; and each of the one or more convertible tables and/or one or more convertible seats comprises: a holder mounted on a first mounting structure of the main body, the holder comprising a biasing structure, one or more flexible bands extendably received in the holder and biased by the biasing structure in a retracted state, and a fastening structure mounted on a second mounting structure of the main body opposite to the first mounting structure, for fastening and tightening the one or more flexible bands thereto when the one or more flexible bands are in an extended state extending out of the holder.

In some embodiments, the additional space is equipped with a sleeping accessory.

In some embodiments, the roof structure is reversibly upwardly extendable from a folded configuration to an extended configuration for providing the additional space therein.

In some embodiments, the folded configuration of the roof structure is for a driving state of the vehicle and the extended configuration is for a camping state of the vehicle.

In some embodiments, the vehicle is a sport utility vehicle.

According to one aspect of this disclosure, there is provided a vehicle comprising: a main body enclosing a main interior space therein, the main interior space comprising a front-seating area having therein at least one front seat and a rear-seating area for receiving therein one or more rear seats, the main body comprising an opening on a roof thereof; an extendable roof structure on top of the main body and coupled thereto, the extendable roof structure reversibly upwardly extendable from a folded configuration to an extended configuration for providing an additional space therein accessible from the main interior space through the opening; and a reconfigurable separation structure at or adjacent the interface of the extendable roof structure and the main body, for forming at least a portion of the floor of the extendable roof structure and/or at least a portion of the roof of the main body when the separation structure is in a closed state, and for accessing the additional space from the main interior space of the main body when the separation structure is in an open state.

In some embodiments, the separation structure is removable.

In some embodiments, the separation structure is upwardly rotatable.

In some embodiments, the separation structure is downwardly rotatable.

In some embodiments, the separation structure comprises at least one hinged roof portion.

In some embodiments, the separation structure comprises at least two hinged roof portions.

In some embodiments, one of the hinged roof portions is of a length greater than the other hinged roof portion.

In some embodiments, one of the hinged roof portions is about a front side of the opening and is downwardly and forwardly rotatable, and the other hinged roof portion is about a rear side of the opening and is downwardly and rearwardly rotatable.

According to one aspect of this disclosure, there is provided a method for modifying a vehicle, the vehicle comprising a main body enclosing a main interior space therein, the main interior space comprising a front-seating area having therein at least one front seat and a rear-seating area for receiving therein one or more rear seats, the method comprising: removing a portion of a roof of the vehicle, thereby creating an opening in the roof; equipping the vehicle with a separation structure spanning the opening; attaching an extendable roof component, the extendable roof component spanning the separation structure and reversibly upwardly extendable to provide an additional space exterior to and above the main body of the vehicle; and installing a shower pan on or in a floor of the main body extending from a location in the rear-seating area towards a rear end of the main body.

In some embodiments, the method further comprises: coupling a shower-pan cover to the shower pan, the shower-pan cover being reconfigurable for proving access to the shower pan.

In some embodiments, said removing the portion of the roof comprises removing a moon roof, a sunroof, or a panoramic roof.

In some embodiments, said attaching the extendable roof component comprises attaching the extendable roof component to one or more roof rails or a roof rack.

In some embodiments, the method further comprises: removing the one or more rear seats.

In some embodiments, the method further comprises: making the one or more rear seats removably attachable to the main body in the rear-seating area thereof.

In some embodiments, the method further comprises: making the one or more rear seats slidable for providing access to the shower pan.

In some embodiments, the method further comprises: connecting the shower pan to one or more rear seats.

In some embodiments, the method further comprises: installing a water source in the vehicle.

In some embodiments, the method further comprises: installing a heat source in the vehicle for heating the additional space.

Other aspects and embodiments of the disclosure are evident in view of the detailed description provided herein.

### BRIEF DESCRIPTION OF THE DRAWINGS

These and other features of the present disclosure will become more apparent in the following detailed description in which reference is made to the appended drawings. The appended drawings illustrate one or more embodiments of the present disclosure by way of example only and are not to be construed as limiting the scope of the present disclosure.

FIG. 1A is a schematic perspective view of a vehicle comprising a main body and an extendable roof structure having openings at corresponding locations for access between the main body and the extendable roof structure, according to some embodiments of this disclosure, wherein the extendable roof structure is in a folded configuration;

FIG. 1B is a schematic side view of the vehicle shown in FIG. 1A, wherein the extendable roof structure is in a folded configuration;

FIG. 1C is a schematic side view of the vehicle shown in FIG. 1A, wherein the extendable roof structure is in an extended configuration;

FIG. 2 is a schematic cross-sectional view of the vehicle shown in FIG. 1A along the cross-section line A-A, showing a front and a rear hinged roof portion forming a floor of the extendable roof structure, wherein the extendable roof structure is in a folded configuration;

FIG. 3 is a schematic cross-sectional view of the vehicle shown in FIG. 1A along the cross-section line A-A, showing a front and a rear hinged roof portion forming a floor of the extendable roof structure, wherein the extendable roof structure is in a folded configuration;

FIG. 4 is a schematic cross-sectional view of the vehicle shown in FIG. 1A along the cross-section line A-A, showing the rear hinged roof portion rotated to an open position for access between the main body and the extendable roof structure;

FIG. 5 is a schematic cross-sectional view of the vehicle shown in FIG. 1A along the cross-section line A-A, showing the rear hinged roof portion rotated to an open position and one or more rear seats in a folded configuration;

FIG. 6 is a schematic cross-sectional view of the vehicle shown in FIG. 1A along the cross-section line A-A, showing the rear hinged roof portion rotated to an open position and the one or more rear seats removed for accessing a shower pan extending at least in a rear-seating area of the main body;

FIG. 7 is a schematic cross-sectional view of the vehicle shown in FIG. 1A along the cross-section line A-A, showing the front and rear hinged roof portions rotated to respective open positions for access between the main body and the extendable roof structure;

FIG. 8 is a schematic cross-sectional view of the vehicle shown in FIG. 1A along the cross-section line A-A, showing the front and rear hinged roof portions rotated to respective open positions and the one or more rear seats removed for accessing the shower pan;

FIG. 9 is a schematic cross-sectional view of the vehicle shown in FIG. 1A along the cross-section line A-A, showing the front and rear hinged roof portions rotated to respective open positions and the one or more rear seats removed, wherein a shower-pan cover is rotated to an upright position for accessing the shower pan;

FIG. 10 is a schematic cross-sectional view of the vehicle shown in FIG. 1A along the cross-section line A-A, showing a shower kit is set up above the shower pan;

FIG. 11 is a schematic cross-sectional view of the vehicle shown in FIG. 1A along the cross-section line B-B, showing the location of the shower pan in the main body of the vehicle;

FIG. 12 is a schematic side view of the vehicle shown in FIG. 1A, according to some embodiments of this disclosure, showing the locations of water tanks in the main body of the vehicle;

FIG. 13 is a schematic cross-sectional view of the vehicle shown in FIG. 1A along the cross-section line C-C, showing the locations of water tanks in the main body of the vehicle;

FIG. 14 is a schematic cross-sectional view of the vehicle shown in FIG. 1A along the cross-section line A-A, according to some embodiments of this disclosure, showing one or more foldable tables and foldaway seats in the main body of the vehicle;

FIG. 15 is a schematic rear view of the vehicle shown in FIG. 1A, showing one or more storage cabinets in the main body of the vehicle;

FIGS. 16A and 16B are schematic cross-sectional views of the vehicle shown in FIG. 1A along the cross-section line A-A, according to some embodiments of this disclosure, showing the main body of the vehicle comprising reconfigurable rear seats longitudinally slidable for providing access to the shower pan;

FIG. 17 is a schematic cross-sectional view of the vehicle shown in FIG. 1A along the cross-section line A-A, according to some embodiments of this disclosure, showing the main body of the vehicle comprising reconfigurable rear seats longitudinally slidable and foldable for providing access to the shower pan;

FIG. 18 is a schematic cross-sectional view of the vehicle shown in FIG. 1A along the cross-section line A-A, according to some embodiments of this disclosure, showing the main body of the vehicle comprising reconfigurable rear seats longitudinally slidable, foldable, and rotatable for providing access to the shower pan;

FIG. 19 is a schematic cross-sectional view of the vehicle shown in FIG. 1A along the cross-section line A-A, according to some embodiments of this disclosure, showing the front and rear hinged roof portions rotated downwardly for providing privacy protection;

FIGS. 20A and 20B are schematic cross-sectional views of the vehicle shown in FIG. 1A along the cross-section line A-A, according to some embodiments of this disclosure, showing the main body of the vehicle comprising an extendable shower pan and reconfigurable rear seats longitudinally slidable for extending the shower pan and providing access to the extended shower pan;

FIG. 21 is a schematic cross-sectional view of the vehicle shown in FIG. 1A along the cross-section line A-A, according to some embodiments of this disclosure, showing the main body of the vehicle comprising a large rear-seating area having a plurality rows of rear seats and a small trunk;

FIGS. 22A and 22B are schematic cross-sectional views of the vehicle shown in FIG. 1A along the cross-section line C-C, according to some embodiments of this disclosure;

FIG. 23 is a flowchart showing the steps of a process for modifying a conventional vehicle to a vehicle having a livable space;

FIG. 24A is a schematic perspective view of a vehicle comprising a main body and an extendable roof structure coupled together via roof rails, according to some embodiments of this disclosure, wherein the extendable roof structure is in a folded configuration;

FIGS. 24B and 24C area schematic side view and a cross-sectional view, respectively, of the vehicle shown in FIG. 24A, wherein FIG. 24B shows the extendable roof structure in a folded configuration and FIG. 24C shows the extendable roof structure in an expanded configuration and at least one rear interior seat being removed from the vehicle for accommodating a shower pan therein; and

FIG. 25 is a schematic cross-sectional view of the vehicle shown in FIG. 24A along the cross-section line A-A, wherein the extendable roof structure is in an extended configuration.

### DETAILED DESCRIPTION

Unless otherwise defined, all technical and scientific terms used herein generally have the same meaning as commonly understood by one of ordinary skill in the art to which this disclosure pertains. Exemplary terms are defined below for ease in understanding the subject matter of the present disclosure.

### Definitions

“About”, when referring to a measurable value (e.g. a volume), is meant to encompass variations of ±10%, ±5%, ±1%, ±0.5% or ±0.1% of the specified amount. When the value is a whole number, the term about is meant to encompass decimal values, as well the degree of variation just described.

The term “a” or “an” refers to one or more of that entity. As such, the terms “a” (or “an”), “one or more” and “at least one” are used interchangeably herein. In addition, reference to an element or a feature by the indefinite article “a” or “an” does not exclude the possibility that more than one of the elements or the features are present, unless the context clearly requires that there is one and only one of the elements. Similarly, unless clearly intended, reference to an element or a feature in the plurality does not necessitate a plurality.

“Comprise” as is used in this description and in the claims, and its conjugations, is used in its non-limiting sense to mean that items following the word are included, but items not specifically mentioned are not excluded.

Vehicle with a Livable Space

The present disclosure provides vehicles with a livable space and methods of modifying a vehicle to have a livable space. As used herein, the term “livable space” is intended to refer to a space suitable for temporary lodging for at least one person including, but not limited to, a space suitable for sleeping and a space for showering.

The vehicles of the present disclosure may be advantageously suitable for daily commuting compared to conventional recreational vehicles and may not need to be stored at a location separate from an owner's home when the vehicle is not in use. The vehicles disclosed herein may be particularly advantageous over conventional commuter vehicles for outdoor recreational trips such as hiking, camping, long distance driving trips, and/or the like.

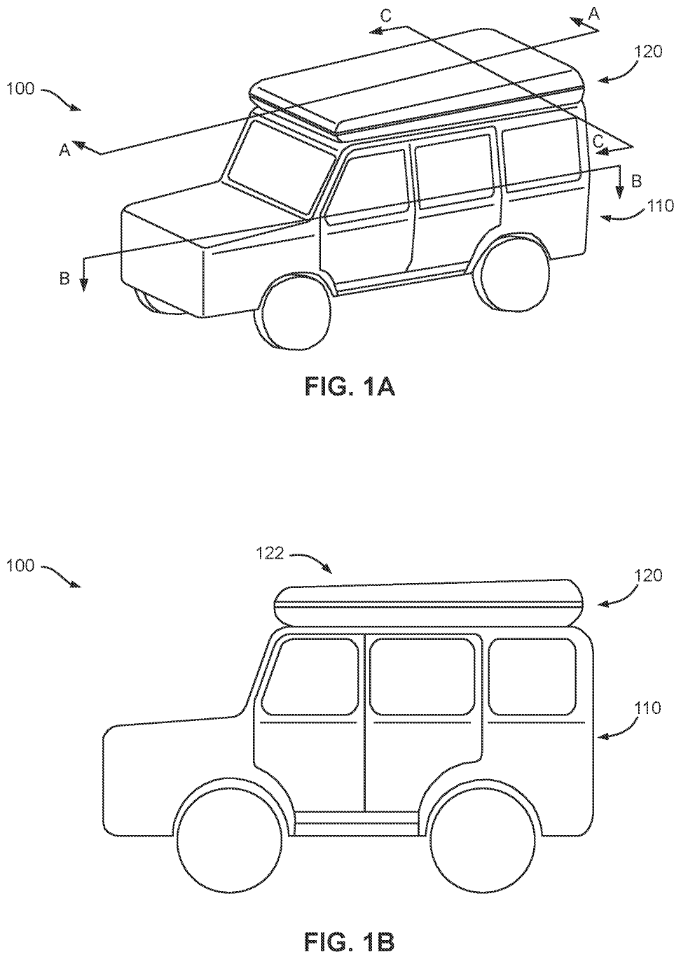

Embodiments of the present disclosure will now be described with reference to FIG. 1 through FIG. 9D, which show non-limiting embodiments of the present disclosure.

Turing now to FIGS. 1A and 1B, an exemplary vehicle according to some embodiments of the present disclosure is shown and is generally identified using reference numeral 100. As shown, the vehicle 100 in this embodiment is a sport utility vehicle comprising a main body 110 and an extendable roof structure 120. While the embodiments of the present disclosure are described in the context of a sport utility vehicle, it will be appreciated that other suitable vehicles such as hatchback sedans, mini vans, and/or the like are equally applicable.

In various embodiments, the vehicle 100 may be convertible between a driving or commute state which may be used for regular and/or daily commute, and a camping state parked at a site (such as a remote camping site) for temporary living and/or accommodation.

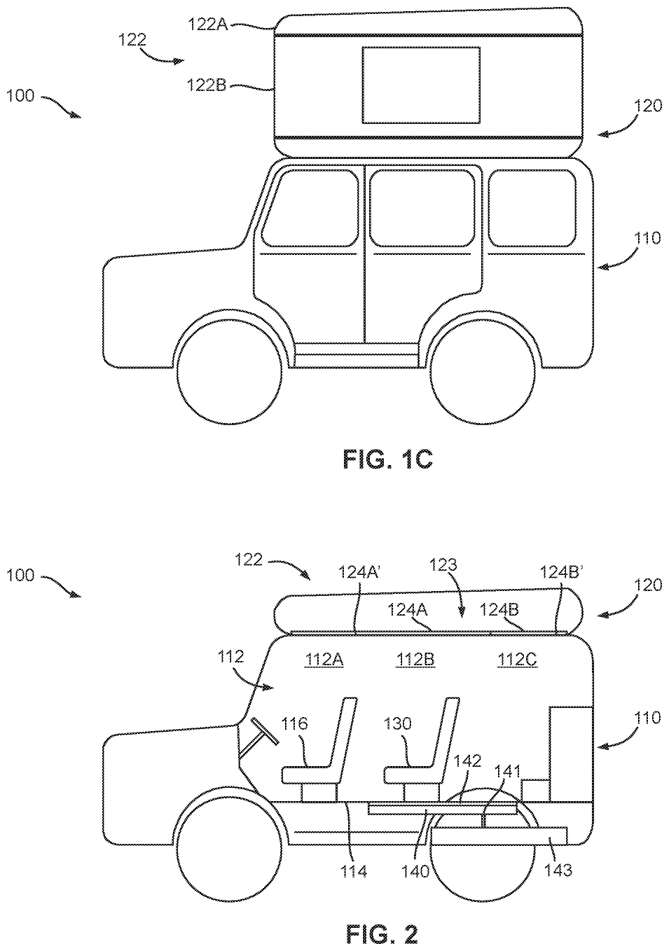

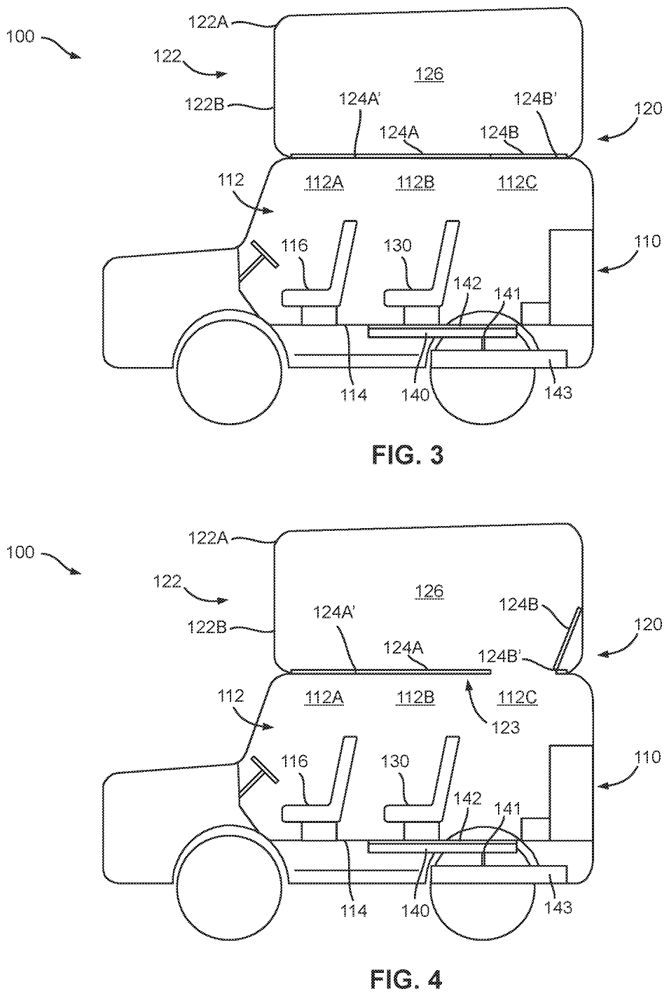

The extendable roof structure 120 shown in FIGS. 1A and 1B is in a folded configuration. FIG. 1C show the vehicle 100 with the extendable roof structure 120 in an extended configuration. FIGS. 2 and 3 are cross-sectional views of the vehicle 100 along the cross-section line A-A shown in FIG. 1A, wherein the extendable roof structure 120 is in the folded configuration as shown in FIG. 2 and is in the extended configuration as shown in FIG. 3.

As shown, the main body 110 comprises a main interior space 112 having a front-seating area 112A, a rear-seating area 112B, and a trunk area 112C, with a floor 114 spanning the areas 112A to 112C. As used herein, the term “front-seating area” is intended to refer to the interior section of the vehicle that is equipped with the steering wheel, the dashboard and at least one front seat 116, such as a driver's seat, shown in FIGS. 2 and 3. The term “rear-seating area” as used herein is intended to refer to the interior section of the vehicle 100 that is contiguous with the front interior area 112A and extends towards the rear of the vehicle 100. The rear-seating area 112B may comprise one or more reconfigurable rear seat 130. The term “trunk area” as used herein is intended to refer to the interior section of the vehicle 100 that is contiguous with the rear-seating area 112B and extends to the rear end of the vehicle 100. The trunk area 112C is often used as a storage space.

The at least one front seat 116 and the one or more reconfigurable rear seat 130 may be one or more single occupant seats (commonly known as captain's chairs), a bench seat, or a combination thereof. The at least one front seat 116 are usually arranged laterally side-by-side and forms a single row. The one or more reconfigurable rear seat 130 may be arranged in one, two, or more rows. For example, in an embodiment, the at least one front seat 116 may be two single occupant seats and the one or more reconfigurable rear seat 130 may be a bench seat. In another embodiment, the at least one front seat 116 and the one or more reconfigurable rear seat 130 may each be two single occupant seats. In a particular embodiment, the one or more reconfigurable rear seat 130 is a foldable bench seat.

The extendable roof structure 120 comprises an extendable roof enclosure 122 having an upper end 122A and flexible sidewalls 122B forming an enclosure. By “extendable roof enclosure”, it is meant that a portion of the roof enclosure 122 is reversibly and upwardly extendable from a first folded configuration (see FIGS. 1A, 1B. and 2) to a second extended configuration (see FIGS. 1C and 3), thereby creating an additional space 126 therein above the main interior space 112.

As those skilled in the art will appreciate, the additional space 126 may be equipped with a sleeping accessory. As used herein, the term “sleeping accessory” is intended to mean any addition that may increase the sleeping comfort for an occupant such as, but not limited to, a mattress (e.g. self-inflating or foam mattress) or a sleeping pad or mat (e.g. a double foam sleeping pad).

The extendable roof enclosure 122 may be of any suitable shape and comprise any suitable material. In an embodiment, the extendable roof enclosure 122 may have a cross-section (along the cross-section line A-A as shown in FIG. 1A) of a rectangular shape, a rounded rectangular shape, a square shape, a rounded square shape, a trapezoid shape, or a rounded trapezoid shape. The upper end 122A may comprise a rigid material and the side walls 122B may be of an accordion fold or a fan fold.

In an embodiment, the first folded configuration of the extendable roof enclosure 122 is a configuration for the driving state of the vehicle 100 and the second extended configuration with the additional space 126 is a configuration for the camping state of the vehicle 100. The extendable roof enclosure 122 may be held in the second extended configuration by any suitable means, such as, but not limited to, one or more telescoping reinforcement posts or an umbrella-type mechanism.

The main body 110 comprises an opening 123 on the roof thereof at a position overlapping at least a portion of the rear-seating area 112B, for example, overlapping at least a rear portion of the rear-seating area 112B and at least an adjacent, front portion of the trunk area 112C. The extendable roof structure 120 also comprises a corresponding opening (also identified using reference numeral 123) on the bottom thereof.

The extendable roof structure 120 also comprises a separation structure 124 at or adjacent the interface of the extendable roof structure 120 and the main body 110 (e.g., on the bottom of the extendable roof structure 120) covering the opening 123 for forming at least a portion of the floor of the extendable roof enclosure 122 and/or at least a portion of the roof of the main body 110. The separation structure 124 may be reconfigurable to open the opening 123 and provide access to the extendable roof structure 120 from the main interior space 112. In some embodiments, the separation structure 124 may be removable. In some embodiments, the separation structure 124 may comprise at least one movable roof portion (such as at least one hinged roof portion).

For example, in the embodiment shown in FIG. 2, the separation structure 124 comprises two hinged roof portions 124A and 124B (collectively identified using reference numeral 124) covering the opening on the bottom of the extendable roof structure 120. In an embodiment, the front hinged roof portion 124A is of a greater length than the rear hinged roof portion 124B.

Herein, the term “at least one hinged roof portion” as used herein is intended to refer to a portion of the floor of the roof enclosure 122 that is moveable about a hinged point such that the at least one hinged roof portion 124 may move from a closed position (e.g., a plane parallel or substantially parallel to the floor 114 of the vehicle 100) to an open position (a position above the plane, below the plane, or both). When in the closed positions, the front and rear hinged roof portions 124A and 124B provide a floor for the additional space 126 (FIG. 3).

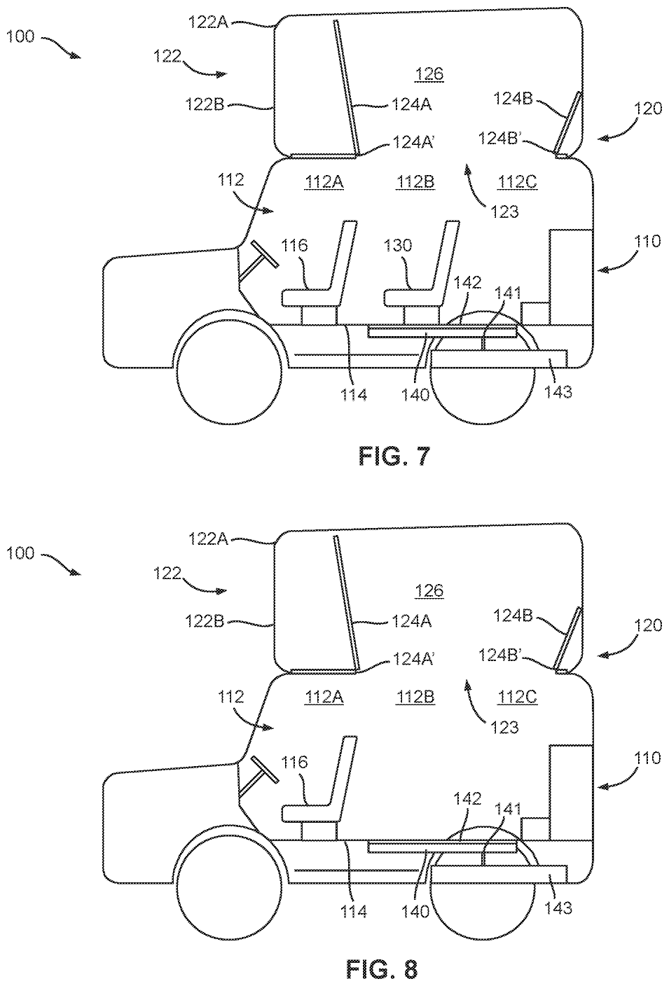

As shown in FIGS. 3 and 7, the front hinged roof portion 124A may be attached to the roof 120 of the vehicle 100 at a front end 124A′ by any means suitable to allow for movement thereof into the additional space 126. Non-limiting examples of attachment means include a strap hinge, a continuous hinge, or an overlay hinge. Similarly, as shown in FIGS. 3 and 4, the at least one rear hinged roof portion 124B may be attached to the roof 120 of the vehicle 100 at a rear end 124B′ by any suitable means such as the described hinge connections.

One or both of the front and rear hinged roof portions 124A and 124B may be connected to an actuator, the actuator slidably connected to a track (not shown). The actuator may be for actuating the movement of the front/rear hinged roof portion 124A, 124B and maintaining the front/rear hinged roof portion 124A, 124B in the open position (see FIGS. 4 and 7). The actuator may be a hydraulic actuator or a pneumatic actuator.

In some embodiments, either one or both of the hinged roof portions 124A and 124B may comprise a locking mechanism to secure the at least one hinged roof portion in the closed position and/or the open position. In an embodiment, maintaining one or both of the front and rear hinged roof portions 124A and 124B in the open position also provides sufficient space for a person to stand in an upright position.

In some embodiments, either one or both of the hinged roof portions 124A and 124B may move into the main interior space 112B.

The at least one hinged roof portion 124A, 124B may advantageously provide access to the additional space 126 from the rear-seating area 112B and/or the trunk area 112C of the vehicle 100. In some embodiments, the at least one hinged roof portion 124 may be used for accessing the additional space 126 from the rear-seating area 112B and/or the trunk area 112C.

For example, as shown in FIG. 4, the vehicle 100 may comprise one reconfigurable rear seat 130 or two reconfigurable single-occupant seats 130 with an access therebetween. The rear hinged roof portion 124B may be rotated to the open position to allow a user to access to the additional space 126 in the extendable roof structure 120.

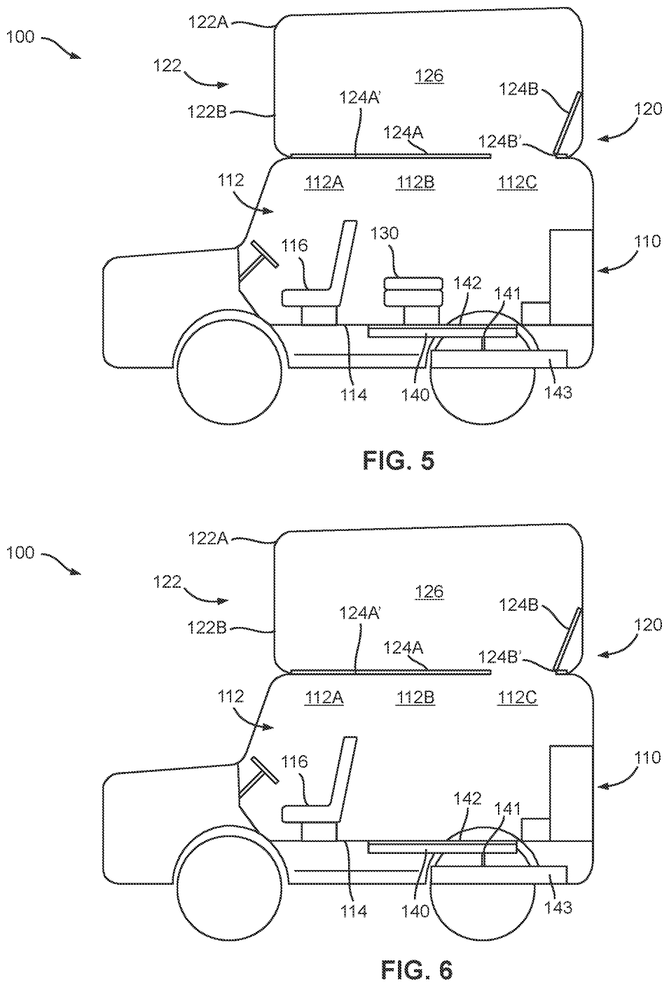

As shown in FIG. 5, the vehicle 100 may comprise one or more foldable rear seats 130. The rear hinged roof portion 124B may be rotated to the open position to allow a user to access to the additional space 126 in the extendable roof structure 120.

As shown in FIG. 6, the vehicle 100 may comprise one or more removable rear seats 130. The rear hinged roof portion 124B may be rotated to the open position to allow a user to access to the additional space 126 in the extendable roof structure 120.

Those skilled in the art will appreciate that the front hinged roof portion 124B may also be rotated to the open position for providing access to the additional space 126 in the extendable roof structure 120 (FIG. 7).

In some embodiments, the main body 110 of the vehicle 100 comprises a shower pan 140 disposed on the floor 114 extending from the rear-seating area 112B to the trunk area 112C. As used herein, the term “shower pan” is intended to refer to a walled structure that may collect, contain, and/or drain a fluid, such as for example water from a shower, and that comprises a shower floor onto which a person may step. As will be appreciated, depending on the shape, the shower pan 140 may comprise a single, continuous wall, or more than one wall. The walls may be substantially or fully perpendicular to the shower floor or may form an obtuse angle with the shower floor. Each wall may be of the same orientation with respect to the shower floor, or not.

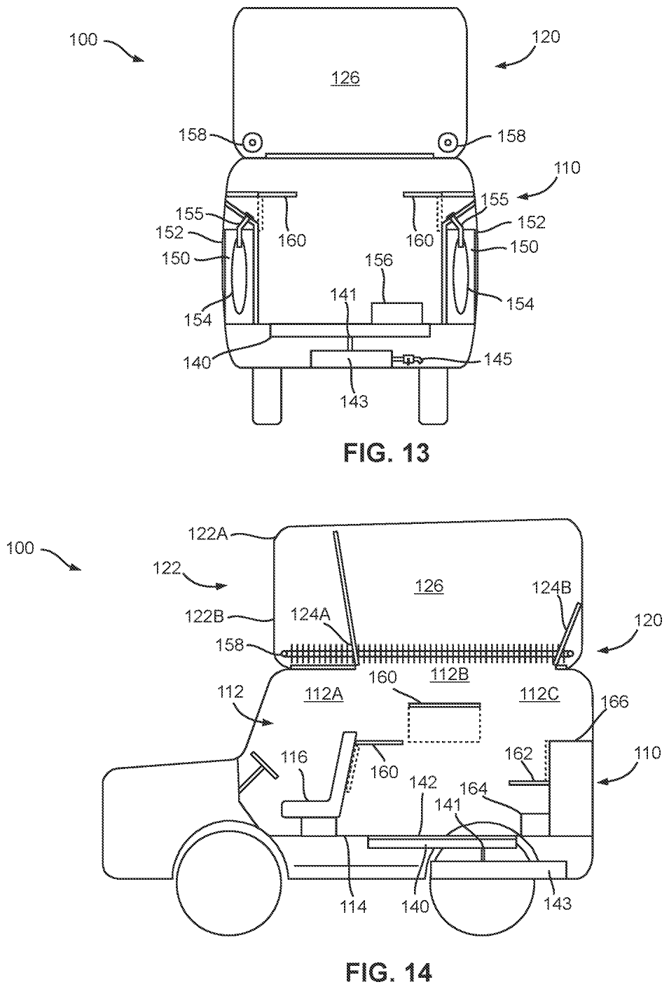

The shower pan 140 may be permanently or removably fixed on the floor 114. In an embodiment, the shower pan is within a recess of the floor 114. The shower pan 140 comprises a drain 141 fluidly connected to a drainage container 143 below the main body 110 for draining a fluid from the shower pan 140 to the drainage container 143 which may discharge the fluid therefrom via a valve-controlled nozzle 145 (see FIG. 13). A removable shower-pan cover 142 is used to openably cover the shown pan 140 and is preferably flush to the floor 114.

The shower pan 140 and the shower-pan cover 142 may be of any suitable water-resistant or water-proof material such as metal, plastic, a composite material, and/or the like. The shower pan 140 and the shower-pan cover 142 may be of the same material, or not. The shower pan 140 and the shower-pan cover 142 may be of any suitable shape and may be the same shape, or not. In an embodiment, the shower pan 140 is of a rectangular, a square, a circle, or an oval shape from a plan view.

As shown in FIG. 2, the shower pan 140 overlaps with the one or more reconfigurable rear seats 130 (i.e., below at least one rear seat 130) when the vehicle 100 is at the driving state. As shown in FIGS. 7 and 8, the one or more reconfigurable rear seats 130 may be removable to enable the use of the shower pan 140 when the vehicle 100 is at the camping state.

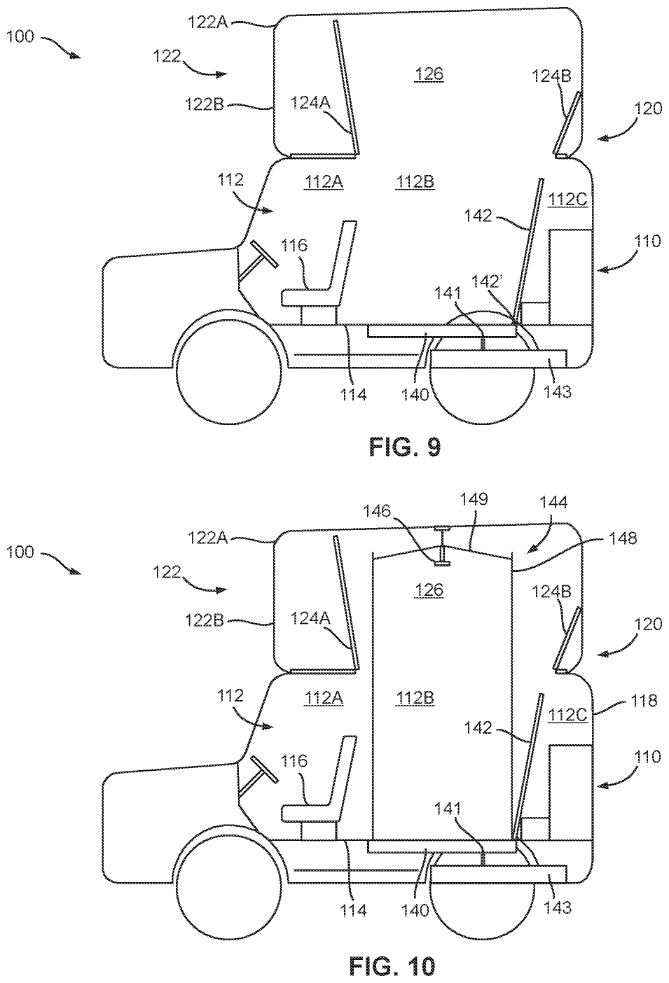

After removing the reconfigurable rear seats 130, the shower-pan cover 142 may be opened to provide access to the shower pan 140. In one embodiments, the shower-pan cover 142 may be removed. In the embodiments shown in FIG. 9, the shower-pan cover 142 may rotate upwardly and rearwardly about a pivot 142′ about the rear end thereof from a closed position covering the shower pan 140 (see FIG. 8) to an open position away from the shower pan 140 thereby providing access to the shower pan 140. In these embodiments, the shower-pan cover 142 comprises a structure (e.g., a suitable length and/or width with a suitable opaque material) suitable for, when in the open position, overlapping with at least a portion of a rear window 118 of the main body 110 and providing a privacy barrier. Of course, those skilled in the art will appreciate that, in other embodiments, the shower-pan cover 142 may rotate about a pivot at other suitable positions to provide access to the shower pan 140 (and may or may not provide privacy barrier).

As shown in FIG. 10, the vehicle 100 comprises a shower kit 144 installable above the shower pan 140. The shower kit 144 comprises a showerhead 146 attachable to the upper end 122A of the extendable roof enclosure 122 and a flexible shower enclosure 148 such as a covering, a shower curtain, a drape, or the like hanging from a hanging structure 149 (e.g., a hanger) and extending downwardly to the shower pan 140. In some embodiments, the shower pan 140 may comprise a ferromagnetic sidewall or a plurality of ferromagnetic pieces on the sidewall, and the shower enclosure 148 may comprise a plurality of magnetic blocks (not shown) about the bottom thereof for engaging the ferromagnetic sidewall or ferromagnetic pieces thereof to retain the bottom of the shower enclosure 148 to the sidewall of the shower pan 140. Therefore, a use may comfortably take a shower in the shower enclosure 148 without spilling any water outside thereof. Moreover, the shower enclosure 148 also provide additional privacy.

In some embodiments, the shower kit 144 may be removed when not in use. In some other embodiments, when not in use, the shower kit 144 may be reconfigured to a compact state and retracted to the upper end 122A of the extendable roof enclosure 122 for storage. In some other embodiments, when not in use, the shower kit 144 may be reconfigured to a compact state and retracted to the shower pan 140 for storage.

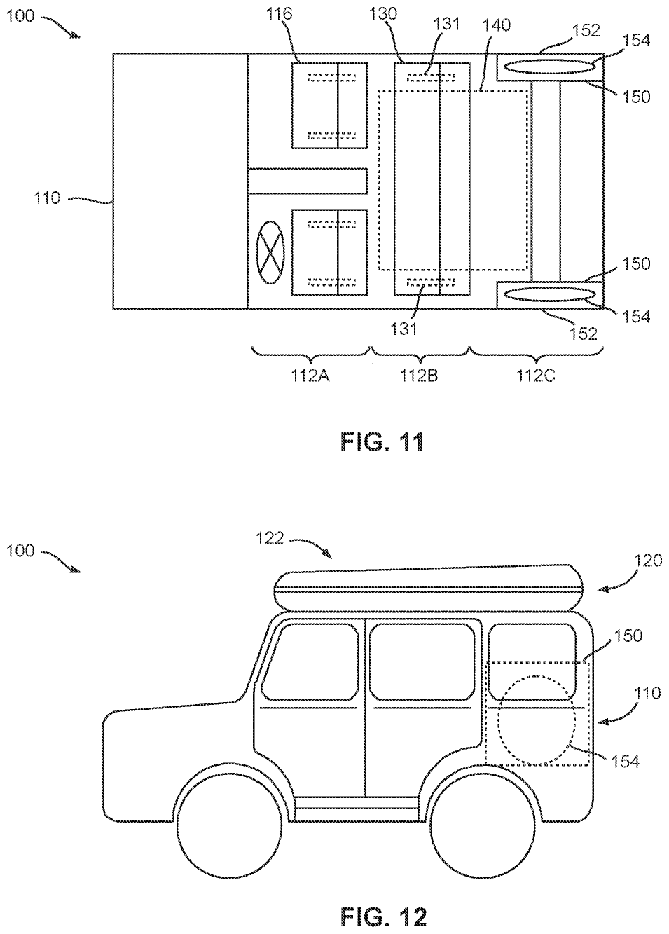

FIG. 11 is a cross-sectional view of the vehicle 100 shown in FIG. 1A along the cross-section line B-B, showing the location of the shower pan 140 in the vehicle 100. As shown, the shower pan 140 longitudinally extends from the rear-seating area 112B to the trunk area 112C and laterally extends between the two anchoring feet 131 of the rear seat 130. The rear seat 130 in these embodiments is removably coupled to the floor 114 of the vehicle 100 via the two anchoring feet 131. As described above, the rear seat 130 may be removed when the vehicle 100 is at the camping state.

As shown in FIGS. 11 to 13, the trunk area 112C may comprise a pair of water tanks 150 adjacent the laterally opposite sidewalls 152 of the main body 110. As those skilled the art will appreciate, the lateral sidewalls 152 of the main body 110 of a vehicle 100 are often outwardly curved thereby providing spaces for accommodating the water tanks 150 without significantly impacting the useful space of the main interior space 112 (and particular the useful space of the trunk area 112C).

In this embodiment, the water tank 150 may comprise a flexible reservoir 154 made of a suitable material such as rubber, flexible plastic, and/or the like, coupled to an inlet 155. The flexible reservoir 154 may have a suitable volume such as between about 5 L and about 40 L. In an embodiment, the reservoir 154 has a volume of about 5 L, about 10 L, about 15 L, about 20 L, about 25 L, about 30 L, about 35 L, or about 40 L. Each reservoir 154 is fluidly connected to the showerhead 146 via a pump (not shown) for providing water for showering. The reservoirs 154 may also fluidly connect to one or more taps or faucets for providing water for other uses.

In the embodiment shown in FIGS. 13 and 14, the trunk area 112C comprises a heating system having a source 156 such as a burner for heating a heating media such as water in a boiler (not shown). The boiler is in fluid communication with a hydraulic expansion tank and a water pump for pumping the heat media to a radiator 158 in the additional space 126 via suitable pipes (such as copper pipes) for heating the additional space 126.

In an embodiment, the heating source may also be used for heating food and/or beverages.

Those skilled in the art will appreciate that the heating source 156 may also be used for heating the main interior space 112.

In an embodiment shown in FIGS. 13 and 14, the rear-seating area 112B and the trunk area 112C may further comprise one or more foldable tables 160, one or more foldable seats 162 coupled to a sidewall of the main body 110, one or more seats (e.g., one or more front seats 116 or one or more rear seats), and/or one or more fixtures such as one or more rear storage cabinets 166. Each of the foldable tables 160 and foldable seats 162 is convertible from a folded position (represented using broken lines in FIGS. 13 and 14) to a unfold position (represented using solid lines in FIGS. 13 and 14) for use. The main body 110 also comprises a step 164 which may also be used for seating.

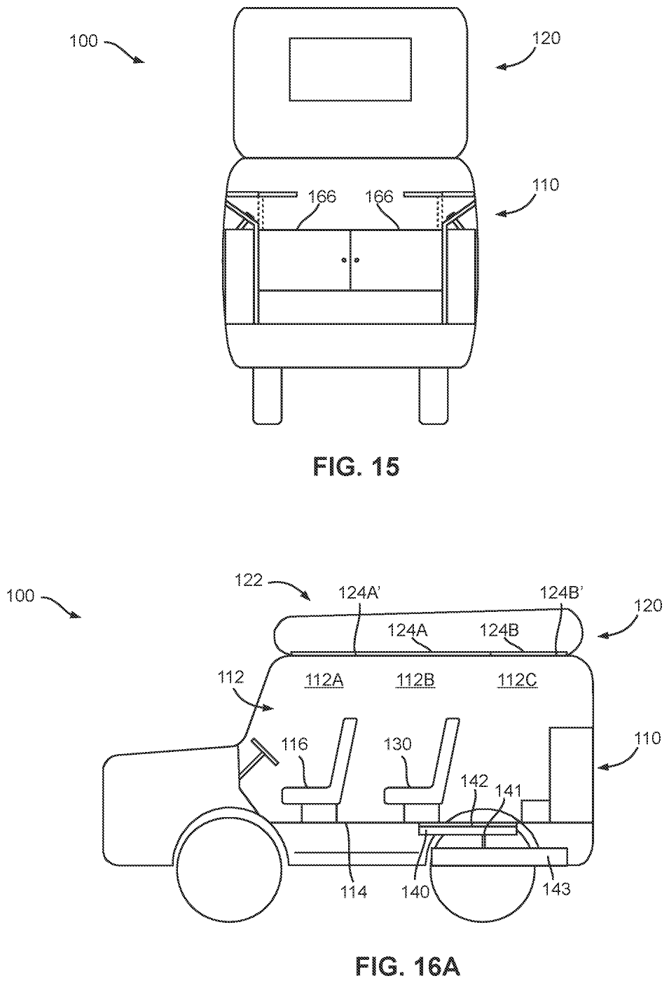

As shown in FIG. 15, at least a portion of the one or more storage cabinets 166 may be outwardly pivotable when a rear access, such as a hatch (not shown), is open such that the storage may be accessible from both inside and outside of the main body 110.

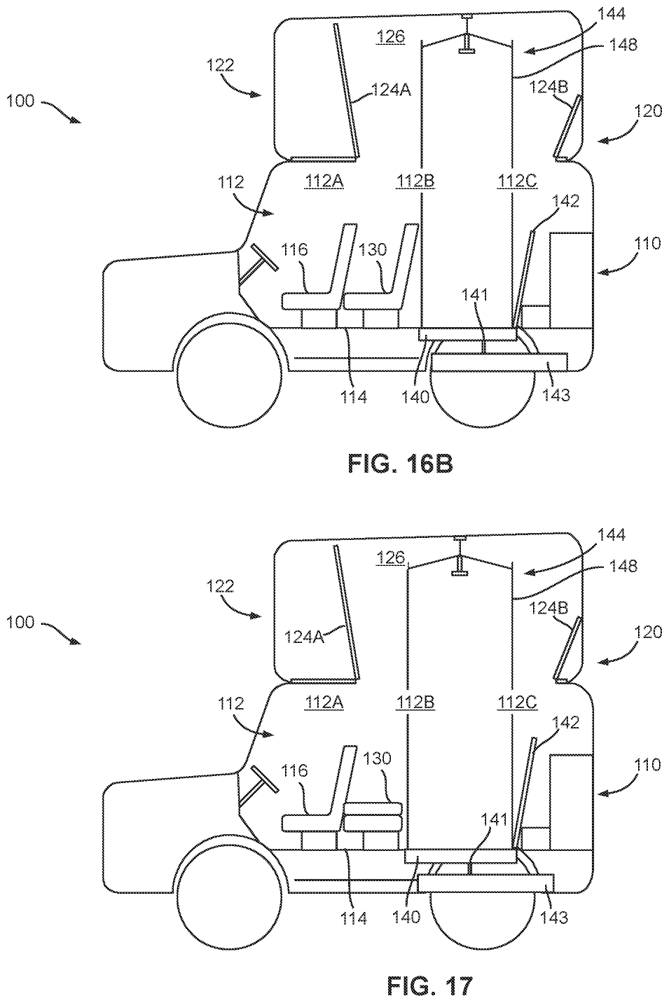

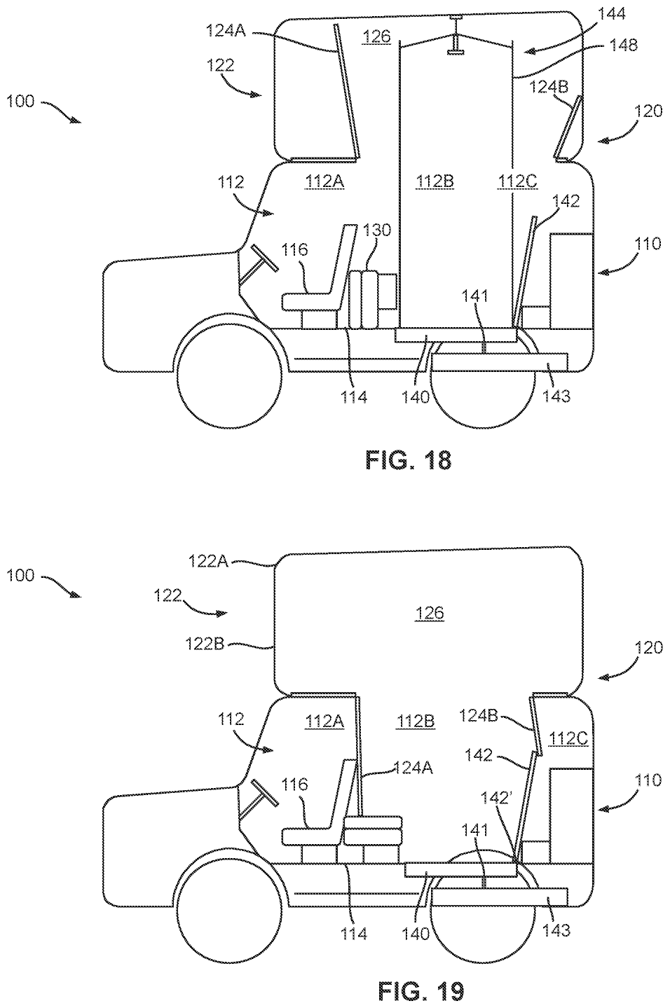

In an embodiment shown in FIGS. 16A and 16B, the shower pan 140 is at a distance from the front seat 116 and extends from a rear portion of the rear-seating area 112B to the trunk area 112C. The reconfigurable rear seats 130 in these embodiments are longitudinally slidable along a track (not shown). As shown in FIG. 16B, when the vehicle 100 is at the camping state, one may slide the reconfigurable rear seats 130 forwardly to provide access to the shower pan 140 for showering as described above.

In an embodiment shown in FIG. 17, the reconfigurable rear seats 130 are longitudinally slidable along a track (not shown) and is also foldable.

In an embodiment shown in FIG. 17, the reconfigurable rear seats 130 are longitudinally slidable along a track (not shown) and is foldable and forwardly rotatable for providing more space for the shower pan 140.

In an embodiment shown in FIG. 19, the two hinged roof portions 124A and 124B are downwardly rotatable. Optionally together with the upwardly rotated shower-pan cover 142, the downwardly rotated roof portions 124A and 124B may provide privacy protection for users in the rear-seating area 112B and/or the trunk area 112C.

In some embodiments, the at least one hinged roof portion 124 may be a single hinged roof portion comprising a movable end distal to a coupling end coupling to the extendable roof enclosure 122. In these embodiments, the movable end comprises a foldable, a collapsible, or a slidable structure that may be folded, collapsed, or slid towards the coupling end to provide access to the additional space 126. In these embodiments, the accessible end is of suitable strength and durability to provide a portion of the floor of the additional space 126.

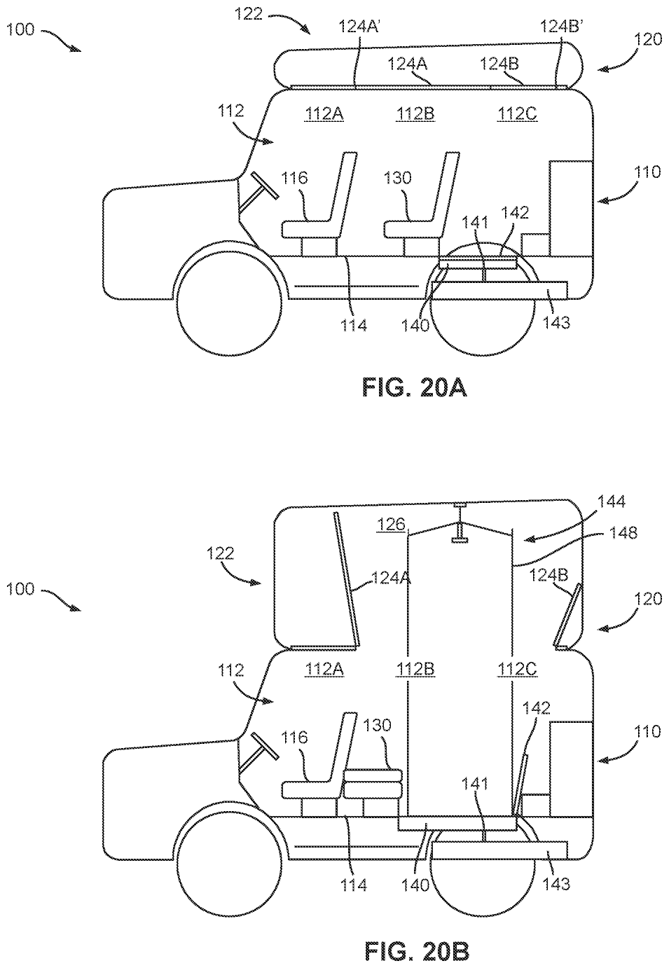

In some embodiments shown in FIGS. 20A and 20B, the shower pan 140 may be a longitudinally extendable shower pan joined to a back portion of the one or more reconfigurable rear seats 130. In such embodiments, the one or more reconfigurable rear seats 130 may forwardly slide to a forward position and longitudinally extend the shower pan 140 for use. In one embodiment, the shower pan 140 may comprise a flexible material such that it is in a partially folded state when the one or more reconfigurable rear seats 130 are in its normal position for seating, and is unfolded when the one or more reconfigurable rear seats 130 are in its forward position.

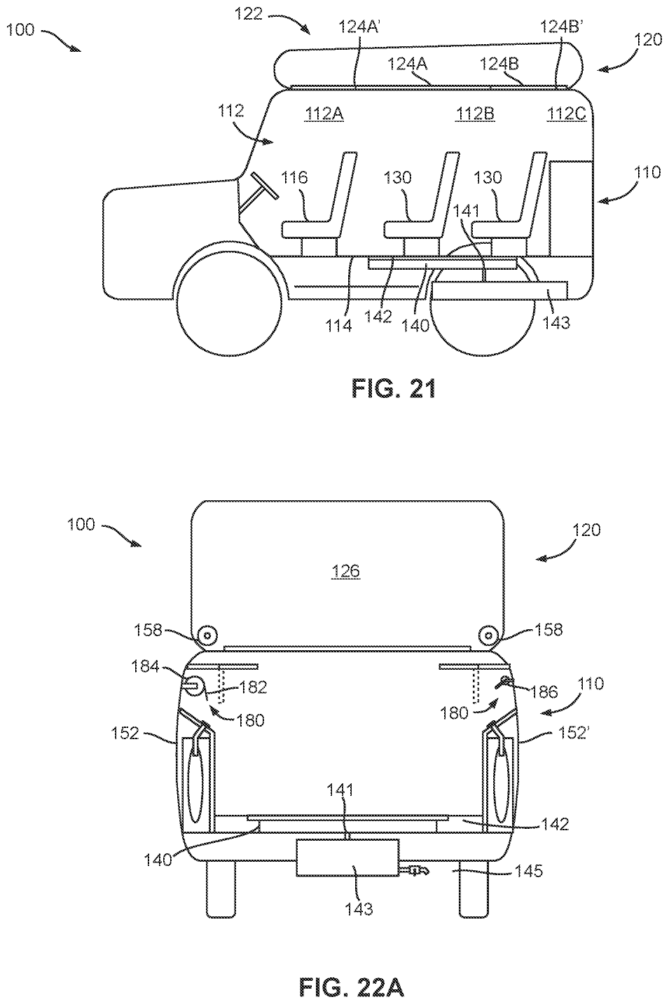

In some embodiments as shown in FIG. 21, the main body 110 of the vehicle 100 may comprise a large rear-seating area 112B (e.g., having multiple rows of reconfigurable rear seats 130). In these embodiments, the shower pan 140 may be entirely positioned in the rear-seating area 112B and does not extend into the trunk area 112C.

In some embodiments, the main body 110 of the vehicle 100 may not comprise any trunk area 112C and the shower pan 140 may be entirely positioned in the rear-seating area 112B.

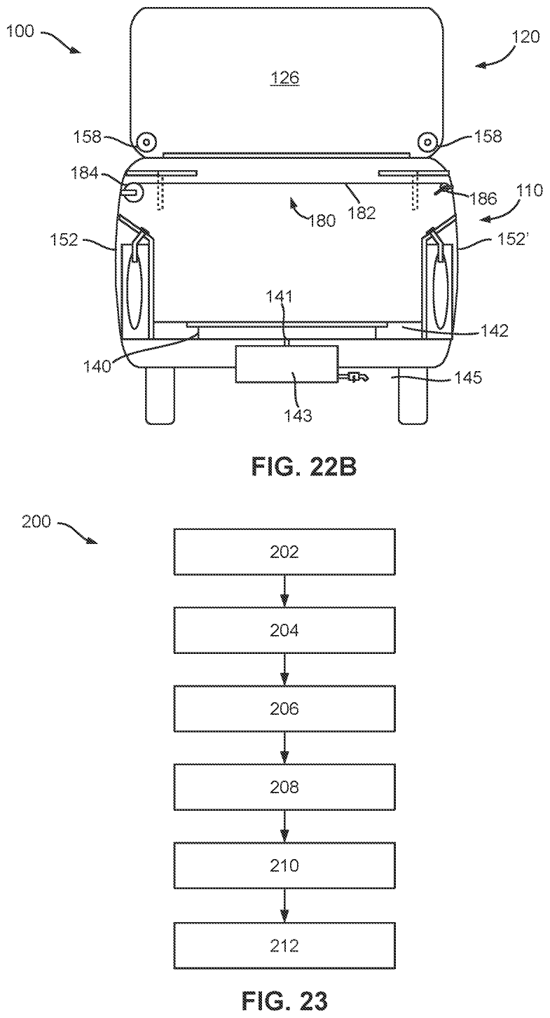

In some embodiments, the vehicle 100 may comprise a convertible table 180. As shown in FIGS. 22A and 22B, the convertible table 180 comprises one or more flexible band 182, such as one or more flexible strips, straps, strings (e.g., in the form of an elongated net), cables, and/or the like, extendably received in a holder 184 mounted on a mounting structure such as a sidewall 152 of the main body 110 at a suitable height. The holder 184 comprises a biasing structure such as a spring (not shown) for retracting the flexible band 182 into the holder 184 and wrapped about a rotatable axis thereof. The vehicle 100 also comprises a fastening structure 186 such as a ratchet assembly or a cable tensioner assembly coupled to another mounting structure such as an opposite sidewall 152′ at a corresponding height. Thus, the flexible band 182 may be pulled out of the holder 184, extended to the sidewall 152′, and engaged with the fastening structure 186. The fastening structure 186 is manually operable or electrically controllable to tighten the flexible band 180 in tension and lock the flexible band 180 in position to form a table.

After use, a user may loosen the flexible band 182, disengage it from the fastening structure 186, and retract it into the holder 184.

In some embodiments, the convertible table 180 may also comprise a rigid board for removably engaging the tightened band 182 to form a rigid tabletop.

In some embodiments, the vehicle 100 may comprise a convertible seat having a structure similar to that of the convertible table 180 and positioned at a suitable lower height for seating.

In some embodiments, one or more of the hinged roof portions 124A and 124B may be configured as a table. In some embodiments, one or more of hinged roof portions 124A and 124B, e.g., the rear hinged roof portion 124B may be foldable to form a table with a suitable length and/or width.

In above embodiments, the roof structure 120 is upwardly extendable for providing the additional space 126. In some embodiments, the roof structure 120 is un-extendable and comprises a fixed structure for providing the additional space 126.

In above embodiments, the separation structure 124 comprises two hinged roof portions 124A and 124B rotatable about respective pivots. In some alternative embodiments, one or more of the roof portions 124A and 124B may be horizontally slidable to open and close.

Those skilled in the art will appreciate that, in some alternative embodiments, the separation structure 124 may comprise a single roof portion (e.g., 124A or 124B) rotatable about a pivot or horizontally slidable to open and close. In some alternative embodiments, the separation structure 124 may comprise or more than two hinged roof portions rotatable about a pivot or horizontally slidable to open and close.

Methods of Modifying a Vehicle to have a Livable Space

FIG. 23 is a flowchart of an exemplary method 200 for modifying a vehicle 100 to have a livable space according to an embodiment of the present disclosure. The method 200 comprises removing a portion of a roof of the vehicle 100, thereby creating an opening in the roof (step 202); equipping the vehicle with at least one hinged roof portion 124 spanning the opening (step 204); attaching an extendable roof structure 120, the extendable roof structure 120 spanning at least the at least one hinged roof portion 124 and reversibly upwardly extendable to provide additional space 126 exterior to and above the main interior space 112 in a main body 110 of the vehicle 100 (step 206); removing one or more rear seats or converting the one or more rear seats to reconfigurable rear seats (e.g., removable, slidable, and/or foldable as described above) (step 208); installing a shower pan 140 on the floor 114 rearwardly extending from the rear-seating area 112B (may or may not into the trunk area 112C depending on the implementation) (step 210); and installing other components such as the water tank 150 and water reservoir 154, foldable tables 160, foldaway seat 162, step 164, cabinets 166, and/or the like (step 212).

The methods disclosed herein may advantageously allow a vehicle owner, for example an owner of a sport utility vehicle, to convert an existing vehicle to a vehicle comprising a temporary accommodation, thereby avoiding the costs of purchasing a recreational vehicle.

The skilled person who has benefitted from the teachings of the present disclosure will appreciate that the steps of the methods disclosed herein have been assigned numbers for the purpose of providing clarity but intervening steps and alternative orders of the steps may be possible. For example, the step 210 of installing a shower pan 140 may be prior to, or concurrent with, step 202 of removing a portion of a roof of the vehicle 100.

The removing step 202 may comprise cutting the roof of the vehicle. The cutting may be by any suitable means such, as for example, a sheet metal cutting tool, a corrugated metal cutting tool, a reciprocating saw, a handheld electric saw, or laser cutting. In an embodiment, the removing comprises removing a moon roof, a sunroof, or a panoramic roof. The removing may comprise both removing a moon roof, a sunroof, or a panoramic roof and cutting a portion of the roof of the vehicle such that the opening is of a suitable size.

The step 204 of equipping the vehicle with at least one hinged roof portion 124 spanning the opening, such as the hinged roof portions 124A and 124B disclosed herein, may comprise attaching the at least one hinged roof portion 124 to a portion of the roof by any suitable means such as the hinges described elsewhere herein. The step 204 may further comprise installing a track around the perimeter of the opening. The at least one hinged roof portion 124 may be equipped with an actuator slidingly coupled to the track, the actuator for actuating the movement of the at least one hinged roof portion 124. The step 204 may further comprise installing a lockable mechanism for locking the at least one hinged roof portion 124 in a position substantially parallel or parallel to the floor of the vehicle 100.

The step 206 of attaching an extendable roof structure 120, such as the extendable roof structure 120 disclosed elsewhere herein, may comprise attaching the extendable roof structure 120 to one or more roof rails or a roof rack. In an embodiment, the one or more roof rails is two roof rails. As will be appreciated, roof rails and roof racks differ with respect to the direction they are mounted on the roof top of the vehicle 100; roof rails typically run across the length (i.e. hood to tailgate) of the roof whereas roof racks typically are oriented across the vehicle (e.g. from the driver's side to the front passenger's side). Both the one or more roof rails and the roof rack may be original to the vehicle 100 or installed on the vehicle most-manufacturing. The attaching may be by any suitable means to secure the extendable roof component to the one or more roof rails or a roof rack such as, but not limited to, screws, bolts, mounting brackets, or a combination thereof.

In embodiments comprising the one or more roof rails or the roof rack, the vehicle 100 may be further equipped with a framing member around the perimeter of the opening to enclose the space between the at least one hinged roof portion 124 and the extendable roof structure 120 created by the one or more roof rails. The extendable roof structure 120 spans at least the at least one hinged roof portion 124 and is reversibly upwardly extendable to provide an additional space 126 exterior to a main body 110 of the vehicle 100. In an embodiment, the extendable roof structure 120 is a hard-shell rooftop tent having at least a portion of the base removed.

The shower pan 140 installed in step 210 may be any shower pan including as described elsewhere herein. The shower pan 140 may be permanently or removably fixed in the main body 110 of the vehicle 100 as described above.

One or more rear seats 130 of the vehicle 100 may be removed in step 208. In some embodiments, the one or more rear seats 130 may be permanently removed. In some alternative embodiments, the one or more rear seats 130 may be modified, conditioned, or otherwise set up to be reconfigurable such that they may be reconfigurably installed in the rear-seating area 112B with sufficient distances therebetween and from the front seat 116 in the driving state, and may be reconfigured (e.g., removed, forwardly slid, folded, and/or rotated) to provide access to the shower pan 140.

Step 212 may comprise installing a water source in the vehicle as an additional step or as part of the installing step 208. The water source may be any of the water sources described elsewhere herein. Step 212 may comprise installing a rear interior divider proximal to a rear passenger window of the vehicle providing a space and disposing the water source in the space. The rear interior divider may comprise any suitable material such as, but not limited to, plastic or metal and may be removable.

Step 212 may also comprise installing a heat source in the vehicle for heating the additional space 126. In an embodiment, the heat source is a boiler equipped with piping such as copper piping extending into the additional space 126. The heat source may be installed in the far rear portion of the rear interior area of the vehicle that is typically used for storage.

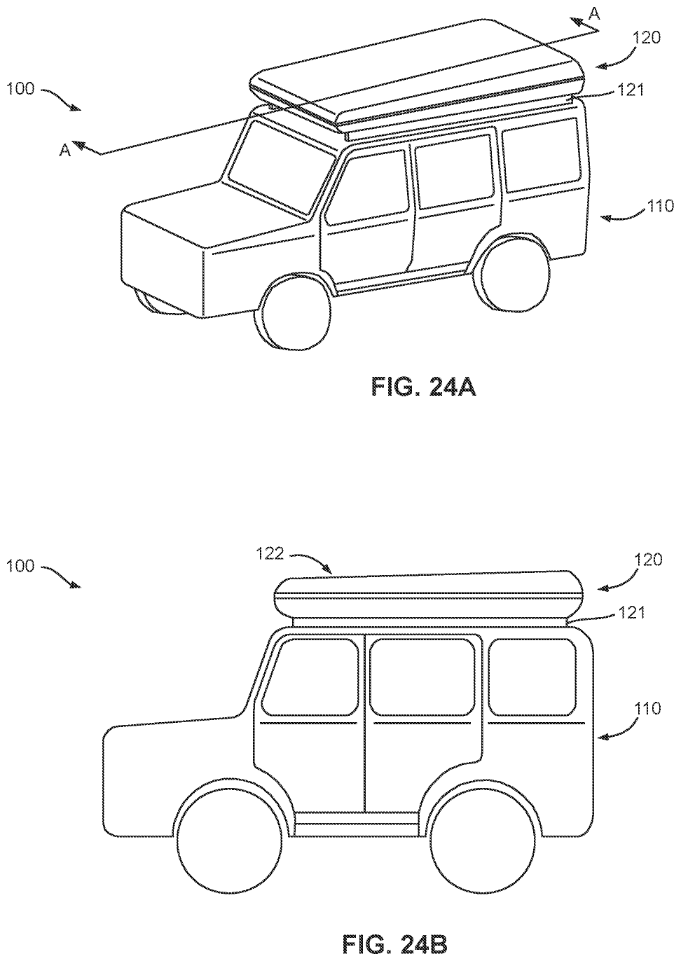

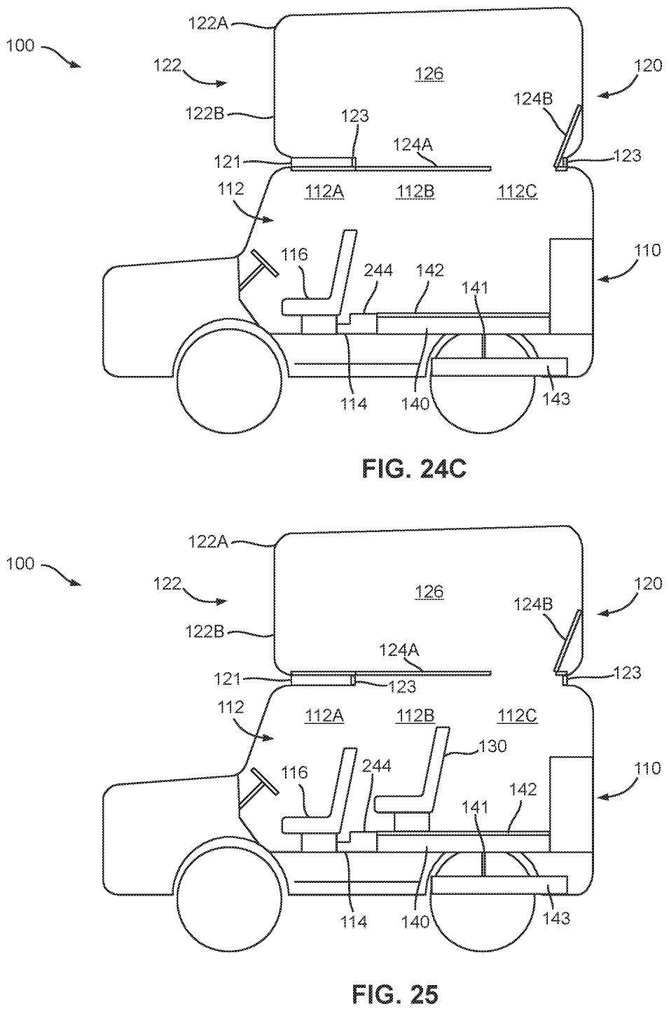

FIGS. 24A to 24C show an exemplary embodiment of a vehicle 100. In this embodiment, the vehicle 100 comprises roof rails 121 onto which the extendable roof enclosure 122 is attached and the hinged roof portions 124A and 124B are rotatably coupled to the roof of the main body 110. The vehicle 100 also comprises a framing member 123 installed between the extendable roof enclosure 122 and the roof of the vehicle 100 to enclose the gap therebetween. The framing member 123 may comprise metal, plastic, composite, or a combination thereof.

The skilled person who has benefitted from the teachings of the present disclosure will appreciate that the vehicle 100 in this embodiment may be provided by direct manufacture or by a method of modifying a vehicle disclosed herein.

As shown in FIG. 24C, in this embodiment, the at least one rear interior seat 130 has been removed from the vehicle 100. However, the skilled person who has benefitted from the teachings of the present disclosure will appreciate that the at least one interior seat 130 may be present in the vehicle as described elsewhere herein.

Also shown in FIG. 24C, the shower pan 140 in this embodiment comprises a platform 244 that may be used to secure the shower pan 140 to the floor 114 of the rear-seating area 112B. The platform 244 may also be used as a surface for placing items such as for example items for showering. Thus, the platform 244 and the shower-pan cover 142 (on top of the shower pan 140) form a raised floor in the driving state with the on or more reconfigurable rear seats 130 thereon.

FIG. 25 a vehicle 100 in some embodiments. The vehicle 100 in these embodiments is similar to that shown in FIG. 24A except that the hinged roof portions 124A and 124B are rotatably coupled to the bottom of the extendable roof structure 122.

Although embodiments have been described above with reference to the accompanying drawings, those of skill in the art will appreciate that variations and modifications may be made without departing from the scope thereof as defined by the appended claims.

1-56. (canceled)

57. A vehicle comprising:
a main body enclosing a main interior space therein, the main interior space comprising a front-seating area having therein at least one front seat and a rear-seating area for receiving therein one or more rear seats, the main body comprising an opening on a roof thereof overlapping at least a portion of the rear-seating area; and
a roof structure on top of the main body and coupled thereto for providing an additional space therein accessible from the main interior space through the opening;
wherein the main body comprises a shower pan on or in a floor thereof extending from a location in the rear-seating area towards a rear end of the main body; and
wherein the one or more rear seats are reconfigurable for providing access to the shower pan.

58. The vehicle of claim 57, wherein the one or more rear seats are removable, slidable, foldable, and/or rotatable for providing access to the shower pan.

59. The vehicle of claim 57, wherein the shower pan is extendable.

60. The vehicle of claim 57, wherein the shower pan longitudinally extends at least in a portion of the rear-seating area and laterally extends between two anchoring feet of the one or more rear seats.

61. The vehicle of claim 57, wherein the main interior space further comprises a trunk area adjacent a rear end of the rear-seating area; and
wherein the shower pan extends from the rear-seating area into the trunk area.

62. The vehicle of claim 57, wherein the main body further comprises a shower-pan cover for openably covering the shower pan.

63. The vehicle of claim 62, wherein, when the shower-pan cover comprises a structure for providing a privacy barrier when the shower-pan cover is in the open position.

64. The vehicle of claim 57, wherein the main body further comprises one or more water tanks positioned adjacent one or more lateral sidewalls thereof.

65. The vehicle of claim 64, wherein the one or more water tanks comprise one or more flexible reservoirs.

66. The vehicle of claim 57, wherein the main body further comprises one or more convertible tables and/or one or more convertible seats; and
wherein each of the one or more convertible tables and/or one or more convertible seats comprises:
a holder mounted on a first mounting structure of the main body, the holder comprising a biasing structure,
one or more flexible bands extendably received in the holder and biased by the biasing structure in a retracted state, and
a fastening structure mounted on a second mounting structure of the main body opposite to the first mounting structure, for fastening and tightening the one or more flexible bands thereto when the one or more flexible bands are in an extended state extending out of the holder.

67. The vehicle of claim 57, wherein the roof structure is reversibly upwardly extendable from a folded configuration to an extended configuration for providing the additional space therein.

68. A vehicle comprising:
a main body enclosing a main interior space therein, the main interior space comprising a front-seating area having therein at least one front seat and a rear-seating area for receiving therein one or more rear seats, the main body comprising an opening on a roof thereof;
an extendable roof structure on top of the main body and coupled thereto, the extendable roof structure reversibly upwardly extendable from a folded configuration to an extended configuration for providing an additional space therein accessible from the main interior space through the opening; and
a reconfigurable separation structure at or adjacent the interface of the extendable roof structure and the main body, for forming at least a portion of the floor of the extendable roof structure and/or at least a portion of the roof of the main body when the separation structure is in a closed state, and for accessing the additional space from the main interior space of the main body when the separation structure is in an open state.

69. The vehicle of claim 68, wherein the separation structure is removable, upwardly rotatable, and/or downwardly rotatable.

70. The vehicle of claim 68, wherein the separation structure comprises at least two hinged roof portions.

71. The vehicle of claim 70, wherein the at least two hinged roof portions comprise a first hinged roof portion about a front side of the opening and downwardly and forwardly rotatable, and a second hinged roof portion about a rear side of the opening and downwardly and rearwardly rotatable.

72. A method for modifying a vehicle, the vehicle comprising a main body enclosing a main interior space therein, the main interior space comprising a front-seating area having therein at least one front seat and a rear-seating area for receiving therein one or more rear seats, the method comprising:
removing a portion of a roof of the vehicle, thereby creating an opening in the roof;
equipping the vehicle with a separation structure spanning the opening;
attaching an extendable roof component, the extendable roof component spanning the separation structure and reversibly upwardly extendable to provide an additional space exterior to and above the main body of the vehicle; and
installing a shower pan on or in a floor of the main body extending from a location in the rear-seating area towards a rear end of the main body.

73. The method according to claim 72 further comprising:
coupling a shower-pan cover to the shower pan, the shower-pan cover being reconfigurable for proving access to the shower pan.

74. The method according to claim 72, wherein said attaching the extendable roof component comprises attaching the extendable roof component to one or more roof rails or a roof rack.

75. The method according to claim 72 further comprising:
removing the one or more rear seats; or
making the one or more rear seats removably attachable to the main body in the rear-seating area thereof; or
making the one or more rear seats slidable for providing access to the shower pan.

76. The method according to claim 72 further comprising at least one of:
connecting the shower pan to one or more rear seats;
installing a water source in the vehicle; and
installing a heat source in the vehicle for heating the additional space.
